(19) United States
(12) Patent Application Publication
(10) Pub. No.: US 2025/0124397 A1
(43) Pub. Date: Apr. 17, 2025

(54) VERIFYING AND TRACKING ASSET STATUS USING BLOCKCHAIN AND AUGMENTED REALITY

(71) Applicant: GOZON, INC., Dover, DE (US)

(72) Inventors: Brandon Lim Lee, Rancho Palos Verdes, CA (US); Douglas Hideo Kato, Rancho Palos Verdes, CA (US); Jason Masayoshi Yamada, Rolling Hills Estates, CA (US)

(21) Appl. No.: 18/917,683

(22) Filed: Oct. 16, 2024

Related U.S. Application Data
(60) Provisional application No. 63/590,629, filed on Oct. 16, 2023.

(51) Int. Cl. G06Q 10/0833; G06Q 20/06; G06Q 30/018

(52) U.S. Cl. CPC G06Q 10/0833; G06Q 20/06; G06Q 30/0185

(57) ABSTRACT

Systems and methods are provided for verifying and tracking asset status using blockchain and augmented reality (AR). An example commerce system may comprise: (1) a signal-emitting tag attached to an asset; and (2) one or more processing resources configured to, in response to at least one of a device of a first user and a device of a second user processing a signal from the signal-emitting tag: (a) determine the processed signal is associated with an identifying blockchain hash code that uniquely identifies the asset within the commerce platform, (b) verify the first user is a valid possessor of the asset based on at least one of the identifying blockchain hash code and a transaction-recording blockchain that records transactions involving the asset on the commerce platform, and (c) permit the first user and the second user to execute a transaction involving the asset via the commerce platform.

### CROSS-REFERENCE TO RELATED APPLICATIONS

The present application claims priority to U.S. Provisional Application No. 63/590,629, filed Oct. 16, 2023, the contents of which are incorporated herein by reference in their entirety.

### TECHNICAL FIELD

The present disclosure relates generally to computerized supply chain management and commerce platforms, and in some examples, verifying and tracking asset status using blockchain and augmented reality (AR).

### DESCRIPTION OF RELATED ART

A blockchain may refer to a distributed ledger with a growing list of records (blocks) that are securely linked together via cryptographic hashes. A block (sometimes referred to herein as a blockchain hash code) may contain a cryptographic hash of the previous block, a timestamp, and transaction data (sometimes represented as a Merkle tree, where data nodes are represented by leaves). Because a respective block contains information about a previous block, linked blocks effectively form a chain. Blockchain transactions are generally understood to be immutable/irreversible as, once they are recorded, the data in any given block cannot be altered retroactively without altering all subsequent blocks.

Augmented reality (AR) may refer to an interactive experience that combines real world and computer-generated 3D content. The content can span multiple modalities, including visual, auditory, haptic, somatosensory, olfactory, etc. AR systems can incorporate a combination of real and virtual worlds, real-time interaction, and accurate 3D registration of virtual and real objects. Overlaid sensory information can be constructive (e.g., additive to the natural environment), or destructive (e.g., masking of the natural environment).

### BRIEF DESCRIPTION OF THE DRAWINGS

The present disclosure, in accordance with one or more various examples, is described in detail with reference to the following figures. The figures are provided for purposes of illustration only and merely depict typical examples.

FIG. 1 depicts an example diagram illustrating a Peer-to-Peer Augmented Reality (P2PAR) workflow facilitated by a commerce platform, in accordance with various examples of the presently disclosed technology.

FIG. 2 depicts an example diagram illustrating another P2PAR workflow facilitated by a commerce platform, in accordance with various examples of the presently disclosed technology.

FIG. 3 depicts an example diagram illustrating a workflow for updating status of an asset to a “Stolen” status within a commerce platform, in accordance with various examples of the presently disclosed technology.

FIG. 4 depicts an example diagram illustrating a workflow for updating status of an asset to a “Sold” status within a commerce platform, in accordance with various examples of the presently disclosed technology.

FIG. 5 depicts an example diagram illustrating a workflow for updating status of an asset to an “Expired or Spoiled” status within a commerce platform, in accordance with various examples of the presently disclosed technology.

FIG. 6 depicts example diagrams illustrating the selling/trading of physical or digital assets leveraging blockchain escrow services, in accordance with various examples of the presently disclosed technology.

FIGS. 7A-7D illustrate example operations that can be performed by a commerce platform to verify and track asset status, in accordance with various examples of the presently disclosed technology.

FIGS. 8A-8B illustrate additional example operations that can be performed by a commerce platform to verify and track asset status, in accordance with various examples of the presently disclosed technology.

FIG. 9 depicts an example workflow for verifying and tracking asset status, in accordance with various examples of the presently disclosed technology.

FIG. 10 illustrates an example computing component that may be used to implement embodiments of the presently disclosed technology.

The figures are not exhaustive and do not limit the present disclosure to the precise form disclosed.

### DETAILED DESCRIPTION

A computerized commerce platform of the presently disclosed technology can utilize signal-emitting tags attached to assets, blockchain technologies, and augmented reality (AR) as a unique system. Such a commerce platform can identify, verify and trace assets from their origin to final destination while being able to actively switch on or off the statuses or functions of the assets. This commerce platform can be utilized to ensure authenticity, inception and traceability of assets and can solve the problems of theft, fraud, counterfeiting, expiration or tampering, etc. The dynamic and secure combination of blockchain technology and Web2 technology with an active trigger mechanism can offer real-time asset tracking, changing of asset statues, and triggering physical activity at/on physical assets.

Certain aspects of the commerce platform are highlighted below.

Augmented Reality (AR)—The commerce platform can use AR and Global Positioning System (GPS) technology to track and verify the holder of assets (physical or digital) and enable triggers to be activated.

Asset identification and Validation—Assets certified on the commerce platform may each receive a unique, tamper-resistant identification tag (sometimes referred to herein as a signal-emitting tag) which emits a wireless signal that can be processed by a user device (e.g., a mobile device) to retrieve information associated with the asset. Examples of signal-emitting tags (which may be included as part of the commerce platform) can include: (1) radio frequency identification (RFID) tags; (2) near-field communication tags; (3) Millimeter wave (mm-Wave) tags; (4) proximity sensor-based tags; etc.

A wireless signal emitted by a signal-emitting tag attached to an asset may be uniquely linked to: (1) a blockchain hash code used for uniquely identifying the asset within the commerce platform (sometimes referred to herein as an identifying blockchain hash code); and (2) a transaction-recording blockchain that records transactions involving the asset on the commerce platform. As described in greater detail below, the commerce platform can also use signals emitted from the signal-emitting tag to identify the location of the asset, and in some cases, visualize the asset using AR.

For a digital asset, the asset can be identified as non-fungible utilizing a unique blockchain hash code associated with the asset. The unique blockchain hash code can also identify/record the asset by name, product number, manufacturing, date, as well as other unique identifiers.

In some implementations, instead of a signal-emitting tag, the commerce platform may utilize passive codes (e.g., quick response (QR) codes) printed on, or otherwise affixed/attached to, a physical asset. Such a passive code printed (or otherwise affixed/attached to) an asset may similarly be linked to: (1) a blockchain hash code used for uniquely identifying the asset within the commerce platform (sometimes referred to herein as an identifying blockchain hash code); and (2) a transaction-recording blockchain that records transactions involving the asset on the commerce platform

Blockchain Ledger—As described above, signals emitted from each signal-emitting tag can be linked to a unique blockchain hash code thereby making the codes associated with the asset decentralized and immutable yet transparent and verifiable. A physical asset can also be linked through a blockchain ledger to digital assets such as NFTs (non-fungible tokens) and be traded, sold, or utilized virtually as well.

On and Off Switch—As described in greater detail below, the commerce platform can determine, based on triggers, whether an asset is valid or invalid, (i.e., on or off). This determination may comprise determining whether a product has been paid for, stolen, exposed beyond its temperature, date, etc.

Bi-Directional Communication with On-Asset Sensors and Alert Devices—As described above (and as described in greater detail below), the commerce platform may comprise signal-emitting tags and other sensors attached/affixed to physical assets. The signal-emitting tags and sensors may be in bi-directional wireless communication with the larger/back-end platform.

For example, the commerce platform may comprise an ink cartridge attached to an asset. When the ink cartridge explodes in response to an asset being stolen, the exploding ink cartridge can send a signal to the commerce platform alerting the commerce platform that the asset has been stolen. As a reverse example, the commerce platform may receive an independent indication (e.g., from an owner of the asset) that the asset has been stolen. Accordingly, the commerce platform can automatically trigger the ink cartridge to explode on the asset.

As another example, the commerce platform may comprise a temperature sensor attached to an asset (e.g., a perishable food asset). When the asset exceeds a threshold temperature, the temperature sensor may send a signal to the commerce platform indicating the asset is invalid (e.g., expired or unsafe to consume because it has exceeded a threshold temperature during transit). In some implementations, the commerce platform may then send a signal to the temperature sensor (or another device attached to the asset) to emit an audio-visual alert (e.g., an indicator light, a sound, a combination of the two) to alert users that the asset is invalid (e.g., expired or unsafe to consume because it has exceeded a threshold temperature during transit).

Overall Event Tracking—As described above, the commerce platform can help determine supply chain events such as expirations, lifecycles, authenticity, and supply chain failures. The commerce platform can also reliably record these events using the immutable nature of blockchain. Owners can also have more control to access information regarding a specified asset-thereby enhancing security and reducing fraudulent sales, theft, and even bodily harm.

Signal-Emitting Tags and Scannable Codes—As described above, the commerce platform can enable signal emitting tags or scannable codes to be assigned to individual assets. These tags/codes can be RFID, chipless RFID, NFC, proximity sensors, dynamic hypertext links, custom sensors, or other types of tags for uniquely labeling assets/products. The commerce platform can use industry standard technologies as well as innovative custom sensors to accommodate specific use cases allowing the commerce platform to be used in myriad verticals and applications. Proprietary tags/codes can include both active (e.g., signal-emitting) tags and passive (e.g., scannable) codes, and can range from small assets to very large assets and may include technologies such as Millimeter Wave (mm-Wave) in the active triggers.

The tags/codes can be designed and programmed to house metadata that can be read into the commerce platform. For example, metadata may comprise single alphanumeric code of at least 20 digits. In some examples, the metadata can contain complex information that further increases the variety of use cases of the commerce platform. The commerce platform can directly store any type of information including images and video. The commerce platform may allow for asset identification metadata to be stored in a database and can have the ability to also store it on the tag/code itself (e.g., if space permits).

Software—The above-described tags/codes and sensors can be triggered either manually (through custom smartphone and web applications or Point-of-Sale (POS) devices), or automatically through mechanisms such as Internet of Things (IoT) devices. These may comprise the “front-end” or client-side of the commerce platform. The ability to trigger events both automatically and manually can provide flexibility to impact the entire supply chain ranging from manufacturers, to end consumers, and everything in between.

Smartphone applications of the commerce platform can be custom built and may include native technologies such as SwiftUI or Kotlin, or hybrid technologies like Flutter or React Native. Other proprietary technologies, Application Programming Interfaces (APIs), or Software Development Kits (SDKs) can be used to assist in the creation of client-side aspects of the commerce platform. These smartphone applications can act as QR code scanners, RFID readers, NFC readers, link enablers, etc.

Web applications of the commerce platform may contain a subset of functionality in the smartphone applications. For example, certain web applications may not be able to perform the scan and reader functions to the same level of complexity as the smartphone applications. Web applications may also use technologies that push users to use the smartphone applications.

There may be server-side software to run the backbone of the commerce platform. This software can include current industry standards like React.JS, Node.JS, and MongoDB as examples of the server-side software. The server-side software can allow the client-side applications to communicate with the servers. Metadata for asset identification may be retained within a database and immutable ledger. In certain examples, the client-side of the commerce platform may not communicate directly with the database. In these examples, communication with the database may be facilitated through the server-side of the commerce platform. Examples of metadata for asset identification may include name, product number, manufacturing details, description, type, product status, location history, etc. The type of metadata that can be stored to identify an asset may only be limited by creativity and use case logic.

Instant Activation—Consumers can have the ability to inform the supply chain by activating an On/Off switch through a custom software component of the commerce platform. This can determine if an asset is valid or not or available or not. Consumers can also confirm receipt of assets. In addition, consumers can control the status of an asset by setting a custom status which may include statuses like “Stolen,” “Manufactured,” “In Stock,” “Purchased,” or any other custom status to suit a particular industry vertical. Smartphone applications can also be used to program the triggers.

When activating the On switch, metadata can be available to broadcast out to other individuals. The metadata may be dormant in the database until the activation. Once the activation occurs, the metadata can be broadcast by the user. Once an Off switch is engaged, the broadcast may stop and the metadata can be moved back to a dormant state.

Peer-to-Peer Augmented Reality (P2PAR)—The commerce platform can also leverage P2PAR. For example, the commerce platform can use motion/location-tracking technologies in in combination with AR technologies that are associated with a set location. Examples of GPS-enabled motion devices can be smartphones or custom GPS devices. These devices may need the ability to accept a precise location. Smartphones can take advantage of built-in GPS. Software applications of the commerce platform may facilitate a peer-to-peer connection that supports AR use with one device broadcasting and the other receiving.

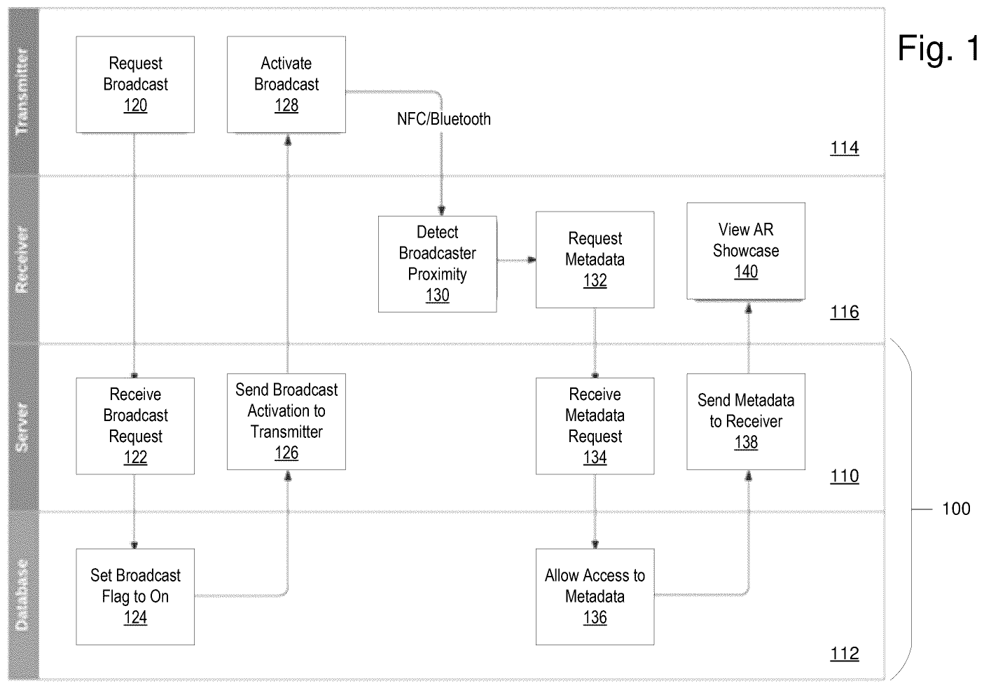

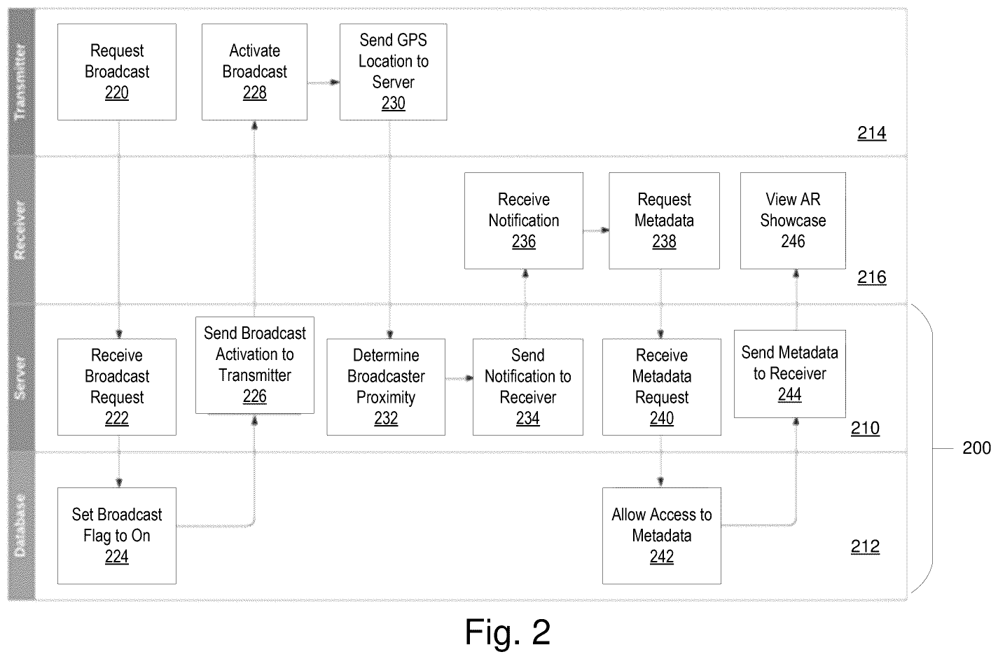

Using this method, the devices can communicate directly with one another through P2P wireless technologies as well as simultaneously communicating with a server in order to retrieve asset-related information and metadata (see e.g., FIGS. 1-2 described in greater detail below).

The P2PAR connection may be established through various methods. One example is using wireless technology such as NFC or Bluetooth to establish a connection. This can be based on proximity in order for the devices to be discoverable to one another. While broadcasting, it can also be possible to notify nearby users that another user is broadcasting and could be scanned.

Another method of communication can be used standalone or in conjunction with the previous method. The devices can be in constant communication with the servers of the commerce platform to transmit their precise location. When their location is transmitted, the location can be entered into a database of the commerce platform as a transient location. The commerce platform can compare user locations and if a match or near match is found, the commerce platform can notify the user. This method may be especially useful if users have turned off NFC and Bluetooth on their phones because the method removes dependence on the users communicating directly through wireless P2P technologies.

GPS devices of the presently disclosed technology may comprise existing products or proprietary device designs that are specifically built for broadcasting and/or receiving use with the commerce platform. Such GPS devices can be products designed and manufactured as bespoke devices with tight integration between the hardware and software applications of the commerce platform.

Database/Datastore-Databases of the commerce platform can communicate with server-side software of the commerce platform through a defined set of protocols and Application Programming Interfaces (APIs). This communication can be important for server-side applications to interact with and manage data stored in the database.

In certain examples of the commerce platform, interaction between a database and server-side software can follow the client-server model. In the client-server model, the database server can act as the central repository for data, and server-side software can send requests to the database server to perform operations like retrieving, updating, or deleting data. In certain implementations of the commerce platform, a client-side application can also be used to interact with the database.

To initiate communication, the server-side software of the commerce platform can establish a connection with the database server of the commerce platform. Once the connection is established, the server-side software can authenticate against the database server. Such authentication may involve providing valid credentials, such as a username and password. The commerce platform can support additional methods of authentication including but not limited to biometrics, Multi-factor Authentication (MFA) methods, and generally available or proprietary hardware or software tokens.

As the data is complex and lends itself towards a flexible structure, the commerce platform can take advantage of NoSQL databases. The commerce platform's NoSQL database can use a variety of data access models, such as document-oriented, key-value, column-family, or graph-based data access models. Server-side software can communicate with the NoSQL database by invoking custom system APIs.

In some implementations, instead of SQL queries, the commerce platform can use methods provided by a database driver. The commerce platform's database can leverage server-side software and may use methods like create, search, or delete to manipulate data within the collection. The database server can process the request to retrieve JSON documents. The commerce platform's database can then transmit the JSON document or data contained in it to the client-side application. Each of the transactions that transmit JSON data can contain a unique hash code that can be recorded to the primary database. The JSON data can also contain large amounts of metadata about an asset. Certain data may also be sent to a second immutable database to maintain complete integrity.

Smartphone and web applications of the commerce platform may interact with the commerce platform through at least two databases.

The first database can be immutable, industry standard, cloud-based, or private on-premise. The first database can also be made up of a combination of types to create the database. This database may function as the primary database that can store any type of data necessary. Various types of media such as videos and images can be stored on a datastore or within the database. The datastore can be industry standard, private, or proprietary. The datastore can leverage technology such as a Content Delivery Network (CDN) to ensure that media such as videos and images are readily and quickly available globally.

The secondary database may be immutable and permanent to ensure that once an entry has been made, it cannot be changed. It can leverage blockchain technology and can be on the public blockchain, private blockchain or a combination of the two methods depending on use case requirements. As mentioned above, metadata such as a blockchain hash code can be sent to this second database.

Non-Fungible Tokens (NFTs)—Non-Fungible Tokens (NFTs) can be stored on decentralized, distributed, immutable digital ledgers called blockchains. Much of the NFT usage currently relates to digital assets. If there is a physical asset involved, it can be represented digitally as an NFT.

The commerce platform may utilize public blockchains that allow for the NFTs to be publicly visible. The commerce platform may also utilize private blockchains as needed to ensure there is added privacy, while providing the necessary transparency when demonstrating ownership or provenance.

The commerce platform can integrate with both public and private marketplaces/blockchains. The commerce platform can cater towards a private proprietary marketplace to further control and secure the buying, selling, and trading of NFTs. The commerce platform can create NFTs through smart contracts that dictate creation, transfer, and ownership of the NFTs. The commerce platform can also act as an intermediary providing virtual and physical escrow services to facilitate this process.

Many NFTs adhere to specific token standards on the blockchain. The commerce platform can use ERC-721 due to its adoption and popularity in the marketplace currently. However, ERC-1155 can be used for more flexible token management or ERC-6551 which allows for NFTs to have ownership instead of the NFT being tied to a wallet. Certain implementations of the commerce platform may utilize Non-Player Characters (NPC) within games, but the uses can be extended to assume profile information that can contain the ownership of NFTs.

NFT metadata about the asset, such as title, description, image or media file URL, and any other relevant attributes can be stored in several ways. Examples may include:
On-Chain: The commerce platform can allow for on-chain storage as some blockchain networks support this. However, this can be expensive and may have limitations in terms of storage capacity.
Off-Chain: The commerce platform may store metadata off-chain in a primary database.
Interplanetary File System (IPFS): The commerce platform may use IPFS, which is a distributed file system.

The commerce platform can use either a private or public blockchain to maintain an immutable record of NFT ownership and transaction history. This transparency can ensure the provenance of each NFT, allowing for origin and ownership history traceability. When NFTs or a physical asset are bought, sold, or transferred, blockchain transactions can be executed to update ownership records.

Dual Blockchain Asset Identification/Validation Lifecycle—Digital and physical assets can be stored within the commerce platform. Two or more blockchain hash codes can be applied to the assets to identify and validate the assets.

Assets can be loaded into the commerce platform by a user. As an asset is entered into the commerce platform, the commerce platform can generate an initial, identifying blockchain hash code for the asset. The identifying block chain hash code can be linked to a public or private blockchain based on security, reliability, and reputation. The identifying blockchain hash code can uniquely identify the asset within the commerce platform and certify it for use within the commerce platform. In certain implementations, assets that do not possess an identifying blockchain hash code may not be certified in the commerce platform and/or may be considered invalid. If an asset has a valid status in the commerce platform, it may be marked as certified until ownership has been established.

The commerce platform can change status of an asset to inactive. In some implementations, this may only be triggered from within the commerce platform and only in the case of a stolen asset or similar situation that requires decommissioning of a physical or digital asset. Other triggers such as exploding cartridges could be bidirectionally leveraged to trigger an asset to be marked as stolen or damaged. The reverse could also be implemented to use the commerce platform to identify an asset as stolen and therefore trigger a release of ink or another staining substance to render a physical asset useless.

When an asset is purchased through the commerce platform, the purchase/transaction may be recorded on a transaction-recording blockchain. This can establish ownership and change the status of the asset to Active. The transaction-recording blockchain may be a separate blockchain from the blockchain the identifying block chain hash code is linked to, or the same blockchain. The transaction-recording blockchain may be configured for processing a high volume of transactions in a short period of time.

Programmed signal-emitting tags (e.g., NFC tags) can also be used to scan in an asset. As that scan takes place, the transaction-recording blockchain can perform the same/similar function as when the asset was initially purchased via the commerce platform. The scan can mark the asset as Active in the transaction-recording blockchain and attach a blockchain hash code of the transaction to the asset.

In some implementations, digital and physical assets certified on the commerce platform can only be transacted through the commerce platform to maintain identification and validation. As an asset is resold in the commerce platform marketplace, the identifying blockchain hash code may be verified to ensure the asset is valid. The transaction-recording blockchain can be used to transfer ownership of the asset and write anew owner's ID to the blockchain. In this way, a complete history of ownership and value can be immutably recorded through the commerce platform and validated by the blockchain.

For many digital and physical assets, there may be no end to the lifecycle as the ability to resell and trade on the commerce platform can continue to keep the asset in an Active state.

FIG. 1 depicts an example diagram illustrating a Peer-to-Peer Augmented Reality (P2PAR) workflow facilitated by a commerce platform 100, in accordance with various examples of the presently disclosed technology.

As depicted, commerce platform 100 may comprise a server 110 and a database 112.

Also depicted in FIG. 1 is a transmitter device 114 and a receiver device 116. Transmitter device 114 may be associated with a first user of commerce platform 100, and receiver device 116 may be associated with a second user of commerce platform 100. As described above, in certain implementations transmitter device 114 and receiver device 116 may implement client-side software components (e.g., as downloaded mobile applications) of commerce platform 100.

As depicted in FIG. 1, transmitter device 114 can execute operation 120 to request to broadcast information associated with an asset owned by the first user.

Server 110 can execute operation 122 to receive the broadcast request and relay the request to database 112. Database 112 can then execute operation 124 to set a broadcast flag associated with the asset to on. Server 110 can then execute operation 126 to send a broadcast activation signal to transmitter device 114.

After receiving the broadcast activation signal from server 110, transmitter device 114 can execute operation 128 to activate a broadcast of information associated with the asset. As depicted, in certain implementations transmitter device 114 can leverage wireless technologies such as NFC and Bluetooth to effectuate such a broadcast.

As depicted, receiver device 116 can execute operation 130 to detect that receiver device 116 is within a threshold proximity to transmitter device 114. In response, receiver device 116 can execute operation 132 to request metadata (e.g., price, manufacturing information, product information, transaction history, etc.) associated with the asset.

Server 110 can execute operation 134 to receive the request for metadata and relay the request on to database 112. In turn, database 112 can execute operation 136 to allow/permit the metadata to be shared with receiver device 116. In some implementations, database 112 may only allow/permit such access after e.g., confirming that receiver device 116 is a device authorized within commerce platform 100 to receive such metadata.

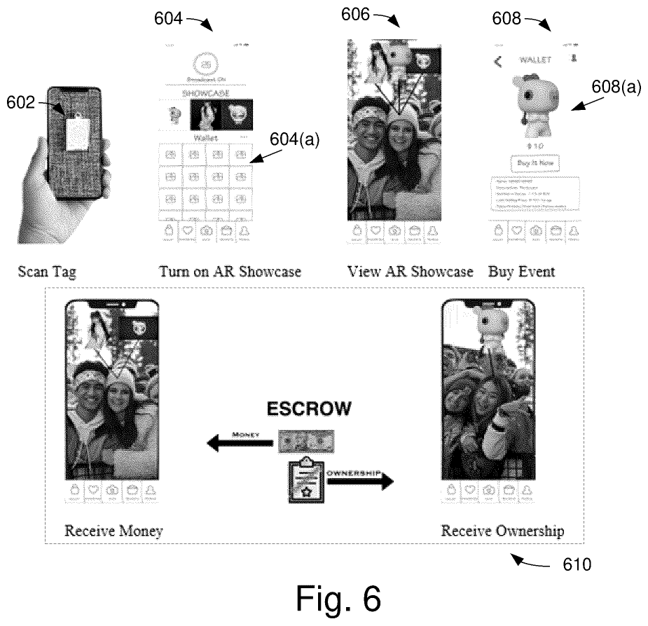

As depicted, server 110 can the execute operation 138 to send the metadata to receiver device 116. Receiver device 116 can then execute operation 140 to view the metadata in an AR showcase (see e.g., FIG. 6 for an example of such an AR showcase).

FIG. 2 depicts an example diagram illustrating another P2PAR workflow facilitated by a commerce platform 200, in accordance with various examples of the presently disclosed technology.

As depicted, commerce platform 200 may comprise a server 210 and a database 212.

Also depicted in FIG. 2 is a transmitter device 214 and a receiver device 216. Transmitter device 214 may be associated with a first user of commerce platform 100, and receiver device 216 may be associated with a second user of commerce platform 100. As described above, in certain implementations transmitter device 214 and receiver device 216 may implement client-side software components (e.g., as downloaded mobile applications) of commerce platform 200.

As depicted in FIG. 2, transmitter device 214 can execute operation 220 to request to broadcast information associated with an asset owned by the first user.

Server 210 can execute operation 222 to receive the broadcast request and relay the request on to database 212. Database 212 can then execute operation 224 to set a broadcast flag associated with the asset to on. Server 210 can the execute operation 226 to send a broadcast activation signal to transmitter device 214.

After receiving the broadcast activation signal from server 210, transmitter device 214 can execute operation 228 to activate a broadcast of information associated with the asset. As described above, in certain implementations transmitter device 214 can leverage wireless technologies such as NFC and Bluetooth to effectuate such a broadcast.

As depicted, transmitter device 214 can execute operation 230 to send its GPS location to server 210. Using transmitter device 214's GPS location, server 210 can execute operation 232 to determine receiver device 216 is within a threshold proximity from transmitter device 214. In some implementations, server 210 may use a GPS location of receiver device 216 to make this determination.

In response to determining receiver device 216 is within the threshold proximity from transmitter device 214, server 210 can the execute operation 234 to send a notification to receiver device 216. The notification may indicate that transmitter device 214 is transmitting information associated with an asset and that transmitter device 214 is within a threshold proximity to receiver device 216.

In turn, receiver device 216 can execute operations 236 and 238 respectively to receive the notification and request metadata associated with the asset. Server 210 can execute operation 240 to receive the metadata request and relay it to database 212. Database 212 can execute operation 242 to allow/permit the metadata request. In turn, server 244 can execute operation 244 to send the requested metadata to receiver device 216. Receiver device 216 can then execute operation 246 to view the received metadata via an AR showcase (see e.g., FIG. 6 for an example of such an AR showcase).

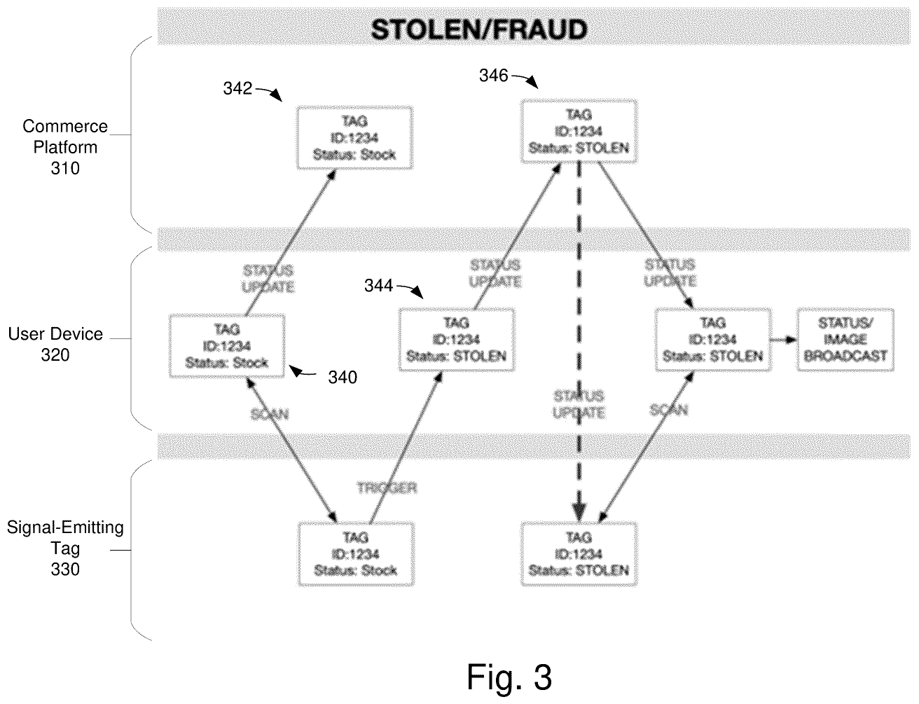

FIG. 3 depicts an example diagram illustrating a workflow for updating status of an asset to a “Stolen” status within a commerce platform 310, in accordance with various examples of the presently disclosed technology.

As depicted, a signal-emitting tag 330 may be attached (or otherwise affixed) to an asset. As described above, in certain implementation signal-emitting tag 330 may be a part of commerce platform 310. Signal-emitting tag 330 may comprise various types of signal-emitting tags, such as, a radio-frequency identification (RFID) tag, a near-field communication (NFC) tag, a Millimeter wave (mm-Wave) tag, a proximity sensor-based tag, etc. As described above, in some implementations signal-emitting tag 330 may comprise a passive tag such as a scannable code (e.g., a quick response (QR) code).

At operation 340, a user device 320 (e.g., a mobile device of a seller, which may implemented a client-side software component of commerce platform 310) can process a signal from signal-emitting tag 330 and indicate to commerce platform 310 that the asset is in stock (e.g., stocked in a store of the seller). At operation 342, commerce platform 310 can determine the processed signal is associated with an identifying blockchain hash code (e.g., ID 1234 provided as a simple illustrative example) that uniquely identifies the asset within commerce platform 310. After performing this determination, commerce platform 310 can record that the asset is in stock on at least one of the identifying blockchain hash code and a transaction-recording blockchain that records transactions involving the asset on commerce platform 310. Commerce platform 310 can then update the status of the asset to “Stock” within commerce platform 310.

As depicted, at operation 344 user device 320 can indicate to commerce platform 310 that the asset has been stolen. In turn, at operation 346 commerce platform can record on at least one of the identifying blockchain hash code and the transaction-recording blockchain that the asset has been stolen. Commerce platform 310 can then update the status of the asset within commerce platform 310 to “Stolen.” As described above, in certain implementations commerce platform 310 can also trigger a physical response at the asset. For example, commerce platform 310 can send a signal to signal-emitting tag 330 to explode an ink cartridge attached to the asset to indicate that the asset has been stolen.

As depicted, after the asset has been assigned the “Stolen” status within commerce platform 310, user devices that subsequently process signals from signal-emitting tag 330 can see (e.g., via an AR display) that the asset has a “Stolen” status.

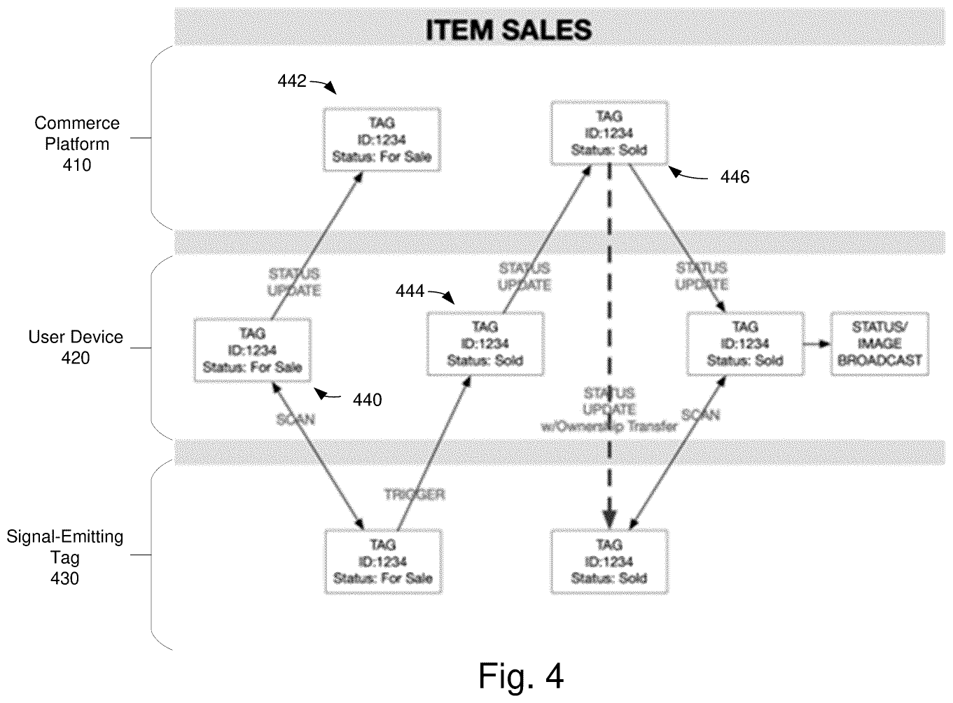

FIG. 4 depicts an example diagram illustrating a workflow for updating status of an asset to a “Sold” status within a commerce platform 410, in accordance with various examples of the presently disclosed technology.

As depicted, a signal-emitting tag 430 may be attached (or otherwise affixed) to an asset. As described above, in certain implementation signal-emitting tag 430 may be a part of commerce platform 410. Signal-emitting tag 430 may comprise various types of signal-emitting tags, such as, a radio-frequency identification (RFID) tag, a near-field communication (NFC) tag, a Millimeter wave (mm-Wave) tag, a proximity sensor-based tag, etc. As described above, in some implementations signal-emitting tag 430 may comprise a passive tag such as a scannable code (e.g., a quick response (QR) code).

At operation 440, a user device 420 (e.g., a mobile device of a seller, which in some examples can implement a client-side software component of commerce platform 410) can process a signal from signal-emitting tag 430 and indicate to commerce platform 410 that the asset is for sale. At operation 442, commerce platform 410 can determine the processed signal is associated with an identifying blockchain hash code (e.g., ID 1234 provided as a simple illustrative example) that uniquely identifies the asset within commerce platform 410. After performing this determination, commerce platform 410 can record that the asset is for sale on at least one of the identifying blockchain hash code and a transaction-recording blockchain that records transactions involving the asset on commerce platform 410. Commerce platform 410 can then update the status of the asset to “For Sale” within commerce platform 410.

As depicted, at operation 444 user device 420 can indicate to commerce platform 410 that the asset has been sold. As described in greater detail below, this may also require user device 420 and/or a user device of a purchaser to process a signal from signal-emitting tag 430 in advance of indicating the asset has been sold.

As depicted, at operation 446 commerce platform can record on at least one of the identifying blockchain hash code and the transaction-recording blockchain that the asset has been sold and that ownership has transferred to the purchaser. Commerce platform 410 can then update the status of the asset within commerce platform 410 to “Sold.” This status update may also indicate/record that the purchaser is now the valid owner of the asset. As described above, in certain implementations commerce platform 410 can also trigger a physical response at the asset. For example, commerce platform 410 can send a signal to signal-emitting tag 430 to turn on an indicator light attached to the asset indicating the asset has been sold.

As depicted, after the asset has been assigned the “Sold” status within commerce platform 410, user devices that subsequently process signals from signal-emitting tag 430 can see (e.g., via an AR display) that the asset has a “Sold” status and that it is in valid possession of the purchaser.

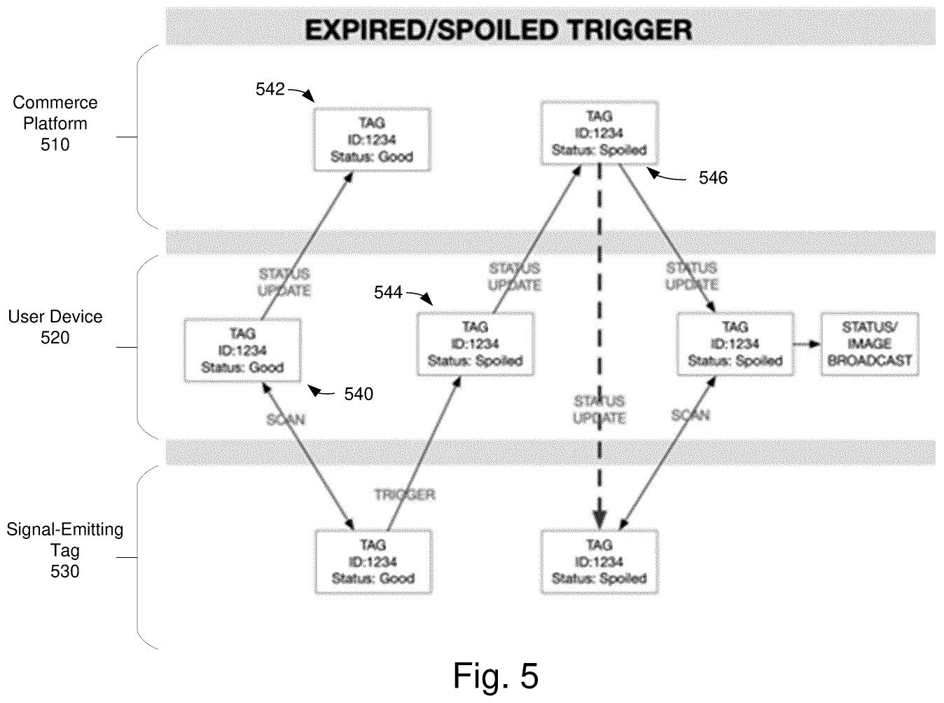

FIG. 5 depicts an example diagram illustrating a workflow for updating status of an asset to a “Expired or Spoiled” status within a commerce platform 510, in accordance with various examples of the presently disclosed technology.

As depicted, a signal-emitting tag 530 may be attached (or otherwise affixed) to an asset. As described above, in certain implementation signal-emitting tag 530 may be a part of commerce platform 510. Signal-emitting tag 530 may comprise various types of signal-emitting tags, such as, a radio-frequency identification (RFID) tag, a near-field communication (NFC) tag, a Millimeter wave (mm-Wave) tag, a proximity sensor-based tag, etc. As described above, in some implementations signal-emitting tag 530 may comprise a passive tag such as a scannable code (e.g., a quick response (QR) code).

In this example, the asset may be a perishable food asset (e.g., a container of frozen tuna) which will expire or spoil after exceeding a threshold temperature. Accordingly, in this example signal-emitting tag 530 may also comprise a temperature sensor, which records a temperature of the asset (or of ambient air around the asset).

As depicted, at operation 540, a user device 520 (e.g., a mobile device of a seller or shipper) can process a signal from signal-emitting tag 530 and indicate to commerce platform 510 that the asset is in good condition (e.g., within an appropriate temperature range). In some examples (e.g., where signal-emitting tag 530 comprises a temperature sensor), processing the signal from signal-emitting tag 530 may indicate to commerce platform 510 the asset is in good condition.

At operation 542, commerce platform 510 can determine the processed signal is associated with an identifying blockchain hash code (e.g., ID 1234 provided as a simple illustrative example) that uniquely identifies the asset within commerce platform 510. After performing this determination, commerce platform 510 can record that the asset is in good condition on at least one of the identifying blockchain hash code and a transaction-recording blockchain that records transactions involving the asset on commerce platform 510. Commerce platform 510 can then update the status of the asset to “Good” within commerce platform 510.

As depicted, at operation 544 user device 520 can indicate to commerce platform 510 that the asset has expired or spoiled. As described above, in other implementations (e.g., where signal-emitting tag 530 comprises a temperature sensor), signal-emitting tag 530 can directly indicate to commerce platform 510 that the asset has expired or spoiled (e.g., based on a temperature reading).

In turn, at operation 546 commerce platform 510 can record on at least one of the identifying blockchain hash code and the transaction-recording blockchain that the asset has been expired or spoiled. Commerce platform 510 can then update the status of the asset within commerce platform 510 to “Expired or Spoiled.” As described above, in certain implementations commerce platform 510 can also trigger a physical response at the asset. For example, commerce platform 510 can send a signal to signal-emitting tag 530 to explode an ink cartridge attached to the asset, or turn on an indicator light, to indicate that the asset has expired or spoiled.

As depicted, after the asset has been assigned the “Expired or Spoiled” status within commerce platform 510, user devices that subsequently process signals from signal-emitting tag 530 can see (e.g., via an AR display) that the asset has the “Expired or Stolen” status.

FIG. 6 depicts example diagrams illustrating selling/trading of physical or digital goods leveraging blockchain escrow services, in accordance with various examples of the presently disclosed technology.

As depicted signal-emitting tags (e.g., signal-emitting tag 602) can be located by utilizing AR, tracking, or by conventional means. As described above, in some implementations signals from the signal-emitting tags can be processed to trigger events.

As depicted in diagrams 604, 606, and 608, a first user can change the status of an asset by adding the asset to a digital wallet (e.g., digital wallet 604 (a) or digital wallet 608 (a)) and setting the status to a sales status. The first user can also turn the broadcast On so that the AR Showcase is viewable by other users (see e.g., diagram 606).

As depicted in diagram 608, when another user views the first user's digital wallet, they can buy the showcase assets available for sale.

As depicted in diagram 610, once the asset is purchased, the escrow process can commence. The selling user (e.g., the first user in this example) may no longer own a digital asset as it goes into escrow, but a physical asset may still need to be transferred. The physical asset can be directly given to the buying user or sent to escrow. The buying user can send money to the escrow. Once the physical asset is received and verified by the buying user, escrow can release the money to the selling user.

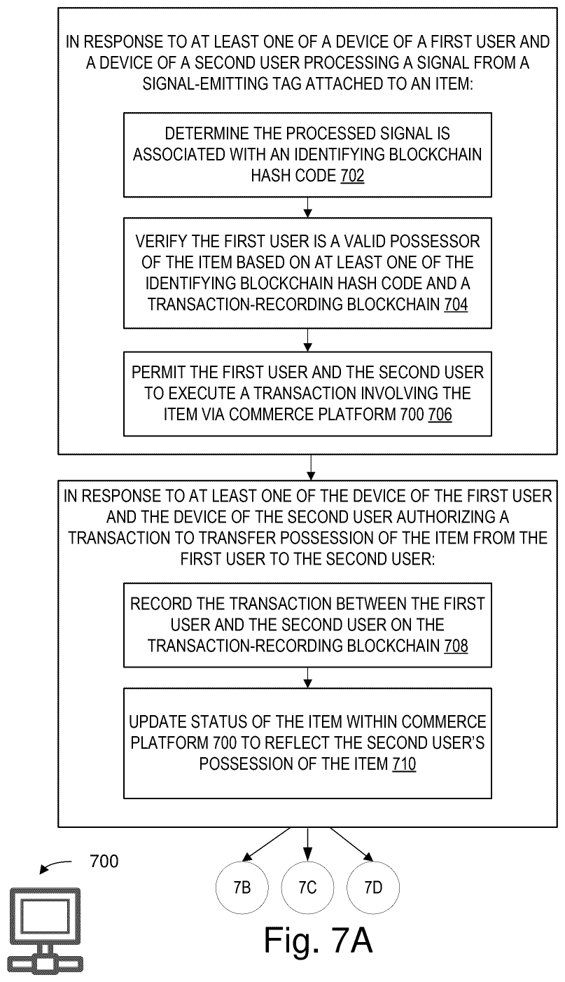

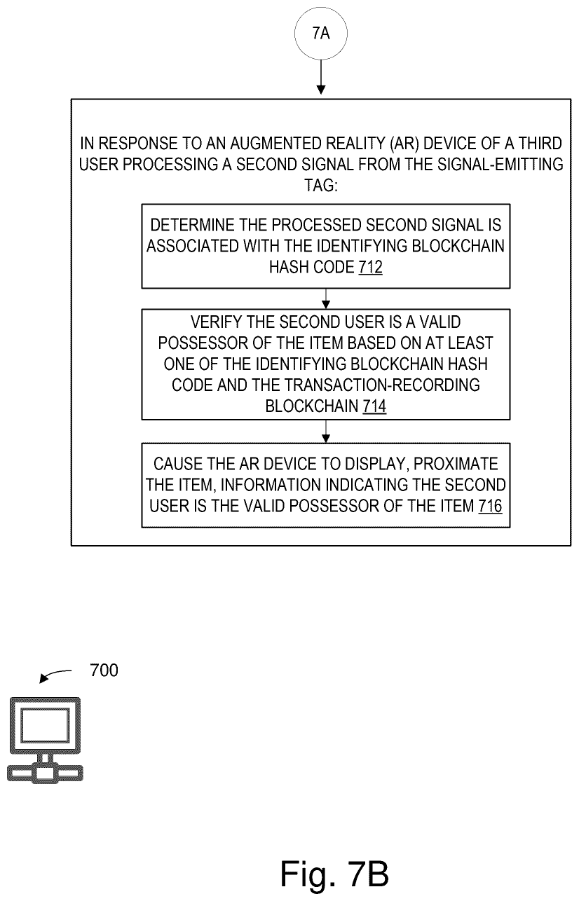

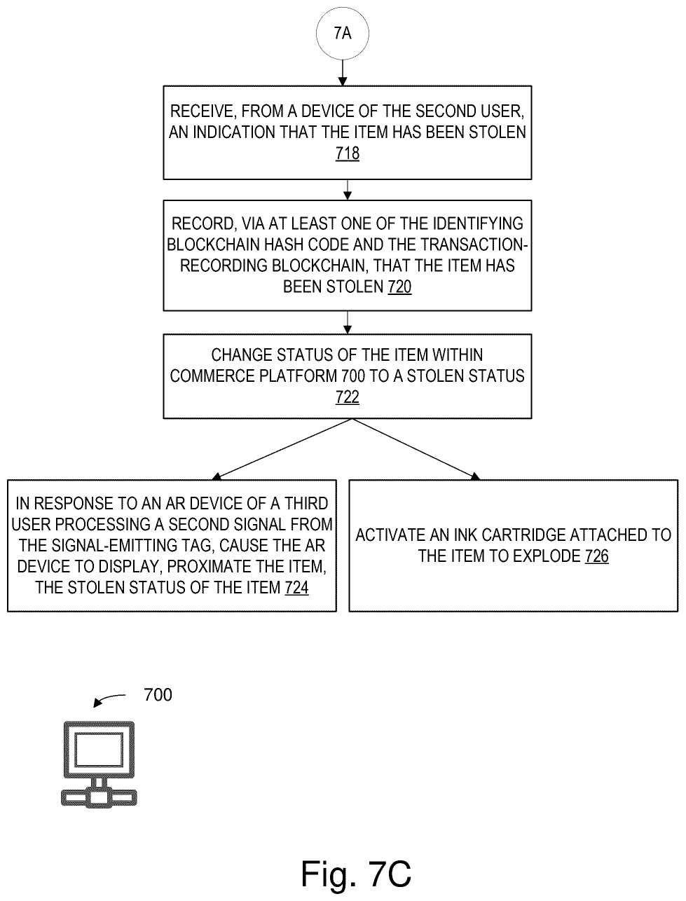

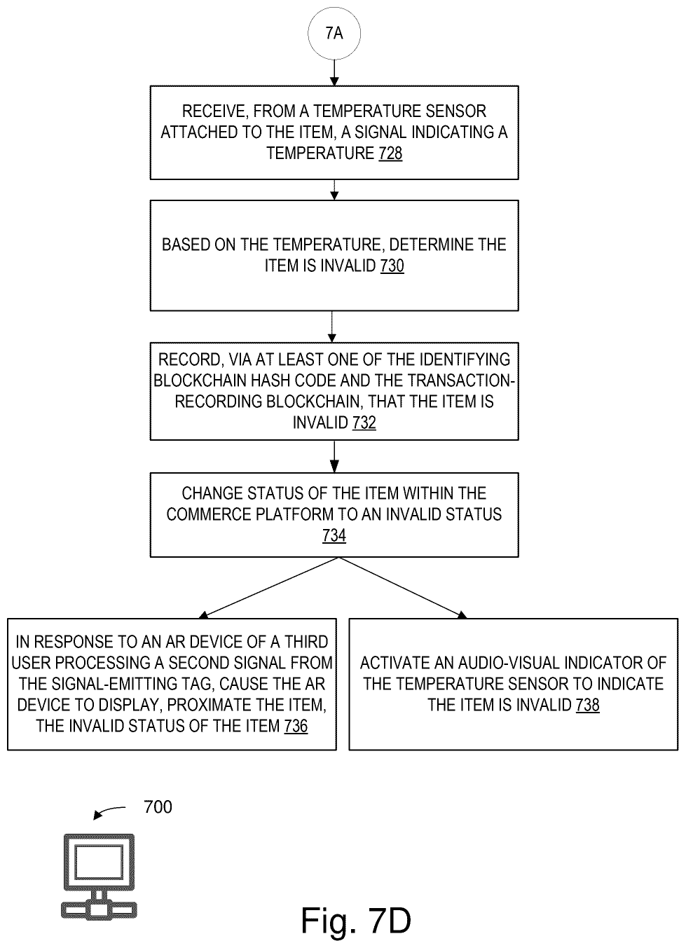

FIGS. 7A-7D illustrate example operations that can be performed by a commerce platform 700 to verify and track asset status, in accordance with various examples of the presently disclosed technology.

As described above, in certain implementations commerce platform 700 may comprise a combination of: (1) a server-side/back-end system (e.g., implemented as a cloud-based system); (2) signal-emitting tags attached to assets; and (3) application instances implemented/downloaded on user devices (e.g., a device of a first user and a device of a second user described below).

Referring now to FIG. 7A, in response to at least one of a device of a first user (e.g., a mobile device of the first user) and a device of a second user (e.g., a mobile device of the second user) processing a signal from a signal-emitting tag attached to an asset, commerce platform 700 can execute operation 702 to determine the processed signal is associated with an identifying blockchain hash code that uniquely identifies the asset within commerce platform 700. As described above, the identifying blockchain hash code can provide an immutable and unique record of the asset within commerce platform 700.

As described above, an original seller of the asset may have earlier requested commerce platform 700 to certify the asset on commerce platform 700. In response, commerce platform 700 may have generated the identifying blockchain hash code for the asset. The signal-emitting tag (which may be a part of commerce platform 700) may have been programmed (or otherwise configured) to emit a signal associated with the identifying blockchain hash code. In some cases, a purveyor of commerce platform 700 may have programmed the signal-emitting tag for this purpose and provided the signal-emitting tag to the original seller to affix/attach to the asset. In other cases, an application instance of commerce platform 700 implemented/downloaded on a mobile device of the original seller may be used to program the signal-emitting tag once affixed/attached to the asset.

The signal-emitting tag may comprise various types of tags, such as, a radio-frequency identification (RFID) tag, a near-field communication (NFC) tag, a Millimeter wave (mm-Wave) tag, a proximity sensor-based tag, etc.

While not depicted in FIG. 7A, in certain implementations a scannable code (e.g., a QR code) may be printed on, or otherwise affixed/attached to the asset instead of the signal-emitting tag. In such implementations, the device of the first user/device of the second user may scan to the code instead of processing a signal from a signal-emitting tag.

As depicted, commerce platform 700 can execute operation 704 to verify the first user is a valid possessor of the asset based on at least one of the identifying blockchain hash code and a transaction-recording blockchain that records transactions involving the asset on commerce platform 700. As described above, in certain implementations the identifying blockchain hash code may be linked to a separate blockchain from the transaction-recording blockchain. In such implementations, the two blockchains may have different characteristics based on their respective roles within commerce platform 700. For example, the transaction-recording blockchain may be configured to execute/record transactions more rapidly than a separate blockchain the identifying blockchain hash code is linked to. Leveraging separate blockchains for the identifying blockchain hash code and the transaction-recording blockchain can also enhance security/reliability for commerce platform 700 by providing redundancy in case one of the blockchains becomes compromised. Notwithstanding above, in some implementations the identifying blockchain hash code may be linked to the transaction-recording blockchain (e.g., for enhanced implementational efficiency).

Responsive to the determinations/verifications of operations 702 and 704, commerce platform 700 can permit the first user and the second user to execute a transaction (e.g., a sale, a consignment, a rental, another type of change of control/possession) involving the asset via commerce platform 700.

Accordingly (and as depicted in FIG. 7A), in response to at least one of the device of the first user and the device of the second user authorizing a transaction to transfer possession of the asset from the first user to the second user, commerce platform 700 can execute operation 708 to record the transaction between the first user and the second user on the transaction-recording blockchain. Relatedly, commerce platform 700 can execute operation 708 to update status of the asset within commerce platform 700 to reflect the second user's valid possession of the asset.

As an illustrative example for FIG. 7A, the asset may be a container of frozen tuna and the signal-emitting tag may be affixed/attached to the container of frozen tuna. The first user may be an agent/employee of a shipper of the container of frozen tuna, and the second user may be an agent/employee of a purchaser of the container of frozen tuna. The transaction may be a consignment from the shipper to the purchaser.

For example, after the shipper agent unloads the container of frozen tuna into a warehouse of the purchaser, either the shipper agent, the purchaser agent, or both, may hold their mobile device proximate (e.g., within a threshold distance of) the signal-emitting tag to process a signal from the signal-emitting tag. In response to the device(s) processing the signal, commerce platform 700 can determine the processed signal is associated with an identifying blockchain hash code that uniquely identifies the container of frozen tuna within commerce platform 700. As described above, an original seller of the container of frozen tuna may have earlier requested commerce platform 700 to certify the container of frozen tuna within commerce platform 700. In response, commerce platform 700 may have generated the identifying blockchain hash code for the container of frozen tuna. The signal-emitting tag may have been programmed (or otherwise configured) to emit a signal associated with the identifying blockchain hash code.

As described above, commerce platform 700 may also verify the container of frozen tuna is in valid possession of the shipper based on at least one of the identifying blockchain hash code and a transaction-recording blockchain that records transactions involving the container of frozen tuna on commerce platform 700. For example, the transaction-recording blockchain may have previously recorded a transaction between the original seller and the shipper when the shipper agent picked up the container of frozen tuna from a premises of the original seller.

In some implementations, commerce platform 700 may only permit the shipper and the purchaser to execute a consignment of the container of frozen tuna from the shipper to the purchaser after performing the above-described determinations/verifications. In certain implementations, commerce platform 700/the transaction-recording blockchain may have also recorded a sale of the container of frozen tuna from the original seller and the purchaser. Accordingly, commerce platform 700 may only permit the shipper to consign the container of frozen tuna to the purchaser after confirming an (authorized) device of the purchaser has processed a signal from the signal-emitting tag.

Referring now to FIG. 7B, in certain implementations after performing the operations of FIG. 7A, and in response to an augmented reality (AR) device of a third user processing a second signal from the signal-emitting tag, commerce platform 700 can execute operation 712 to determine the processed second signal is associated with the identifying blockchain hash code. Relatedly, commerce platform 700 can execute operation 714 to verify the second user is a valid possessor of the asset based on at least one of the identifying blockchain hash code and the transaction-recording blockchain. In response to these determinations/verifications, commerce platform 700 can execute operation 716 to cause the AR device to display, proximate the asset, information indicating the second user is the valid possessor of the asset.

While not depicted directly in FIG. 7B, in some implementations the AR device of the third user may send a request to commerce platform 700 to view certified assets when the AR device is within a threshold distance from the certified assets. Accordingly, when the AR device enters within the threshold distance from the bespoke sneakers, commerce platform 700 may perform the operations of FIG. 7B, or otherwise cause the AR device to display information related to the asset. Commerce platform 700 can use various techniques to determine the AR device has entered within a threshold distance from the asset. For example, commerce platform 700 can determine a distance between the AR device and the asset based on wireless communications between the AR device and the signal-emitting tag. As another example, commerce platform 700 can determine a distance between the AR device and the asset based on GPS coordinates of the AR device and asset respectively, which may be retrieved from GPS sensors associated with the AR device and the asset respectively.

As a second illustrative example for FIG. 7B, the asset may comprise a pair of bespoke sneakers worn by the second user. The signal-emitting tag may be affixed/attached to one of the bespoke sneakers. The third user may be a prospective buyer who encounters the second user on the street. Accordingly, the AR device of the third user (e.g., AR glasses worn by the third user) may process the second signal from the signal-emitting tag in response to, e.g., detecting the third user is looking at the bespoke sneakers worn by the second user and/or detecting the AR device is within a threshold distance from the signal-emitting tag/asset.

In this second illustrative example, after performing the determinations/verifications of operations 712 and 714, commerce platform 700 may cause the AR device of the third user to display, to appear proximate (e.g., to appear within a threshold distance of) the bespoke sneakers, information associated with the bespoke sneakers. Such information may indicate the second user is a valid owner/possessor of the bespoke sneakers, manufacturing or product information associated with bespoke sneakers, a price of the bespoke sneakers, etc. If given this information the third user becomes interested in purchasing the bespoke sneakers, the third user can discuss a transaction with the second user. Such a transaction may be facilitated by commerce platform 700 in the same/similar manner as described in conjunction with FIG. 7A.

Referring now to FIG. 7C, in certain implementations after performing the operations of FIG. 7A, commerce platform 700 can execute operation 718 to receive, from a device of the second user, an indication that the asset has been stolen. Commerce platform 700 can then execute operations 720 and 722 respectively to: (1) record, via at least one of the identifying blockchain hash code and the transaction-recording blockchain, that the asset has been stolen; and (2) change status of the asset within the commerce platform 700 to a stolen status.

Accordingly, in response to an AR device of a third user processing a second signal from the signal-emitting tag, commerce platform 700 can execute operation 724 to cause the AR device to display, proximate the asset, the stolen status of the asset.

Alternatively, or in addition to operation 724, commerce platform 700 can execute operation 726 to activate an ink cartridge attached to the asset to explode (thus indicating that the asset has been stolen). In some implementations, the ink cartridge may be part of commerce platform 700, and may be capable of bi-directional communication with the server/back-end system. In such implementations, activation of the ink cartridge to explode may indicate to commerce platform 700 that the asset has been stolen. In response to receiving this indication from the exploding ink cartridge, commerce platform 700 can perform operations 720 and 722 from FIG. 7C.

Referring again to the second illustrative example discussed above in conjunction with FIG. 7B, the bespoke sneakers may have been stolen from the second user. Accordingly, in response to receiving an indication from a device of the second user (or in some cases, an exploding ink cartridge) that the asset has been stolen, commerce platform 700 may then update the status of the bespoke sneakers to stolen via operations 720-722. Accordingly, the third user may encounter an individual (other than the second user) trying to sell the (stolen) bespoke sneakers on the street. When the AR device of the third user processes the second signal from the signal-emitting tag (e.g., when the third user looks at the bespoke sneakers or the AR device or enters within a threshold distance of the signal-emitting tag), commerce platform 700 can cause the AR device to display, to appear proximate the (stolen) bespoke sneakers, an indication that the bespoke sneakers are stolen. Accordingly, the third user may decide not to purchase the bespoke sneakers, or safely alert the authorities.

Referring now to FIG. 7D, in certain implementations after performing the operations of FIG. 7A, commerce platform 700 can execute operation 728 to receive, from a temperature sensor attached to the asset, a signal indicating a temperature. Commerce platform 700 can then execute operations 730, 732, and 734 respectively to: (1) based on the temperature, determine the asset is invalid; (2) record, via at least one of the identifying blockchain hash code and the transaction-recording blockchain, that the asset is invalid; and (3) change status of the asset within the commerce platform to an invalid status.

Accordingly, in response to an AR device of a third user processing a second signal from the signal-emitting tag, commerce platform 700 can execute operation 736 to cause the AR device to display, proximate the asset, the invalid status of the asset.

Alternatively, or in addition to operation 736, commerce platform 700 can execute operation 738 to activate an audio-visual indicator (e.g., a light, a sound, a combination of light and sound) of the temperature sensor to indicate the asset is invalid. As described above, the temperature sensor may be part of commerce platform 700, and may be capable of bi-directional communication with the server/back-end system.

Referring again to the first illustrative example discussed above in conjunction with FIG. 7A, the container of frozen tuna may expire or present a safety hazard if a temperature of container of frozen (or purportedly frozen) tuna reaches above a threshold temperature. Accordingly, in response to receiving an indication from the temperature sensor that the container of frozen tuna has exceeded the threshold temperature, commerce platform 700 may then update the status of the container of frozen tuna to expired via operations 730-734. Accordingly, when the AR device of the third user (e.g., a second purchaser purchasing the container of tuna form the second user), processes the second signal from the signal-emitting tag (e.g., when the third user looks at the container of frozen tuna or the AR device or enters within a threshold distance of the signal-emitting tag), commerce platform 700 can cause the AR device to display, to appear proximate the (invalid/expired) container of frozen tuna, an indication that the container of frozen tuna is invalid/expired.

Alternatively (or in addition to the paragraph above), commerce platform 700 can send a signal to the temperature sensor to activate an audio-visual indicator of the temperature sensor to indicate the container of frozen tuna is invalid/expired.

In some implementations, commerce platform 700 can associate a change of asset status to the possession of a particular user. In other words, commerce platform 700 can determine whether a change of asset status (e.g., the invalidation/expiration of an asset) occurred during a particular user's valid possession of an asset. For example (and referring to the first illustrative example involving the container of frozen tuna), commerce platform 700 can determine the expiration/invalidation of the container of frozen tuna occurred during the second user's possession (as opposed to during the first user's possession). Commerce platform 700 can make this association/determination based on at least one of the identifying blockchain hash code and the transaction-recording block chain. Accordingly, commerce platform can facilitate a dispute resolution between, e.g., the first user and the second user re: who's possession of the container of frozen tuna caused the expiration/invalidation.

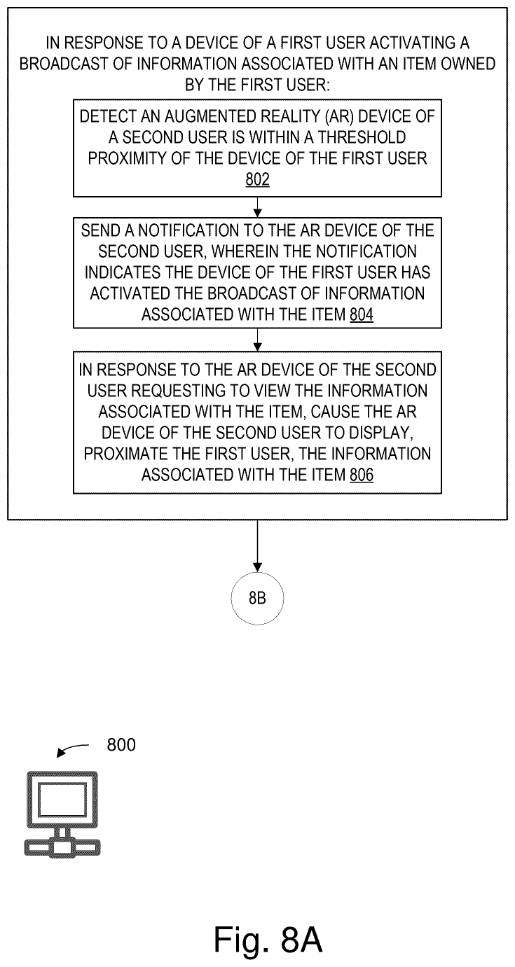

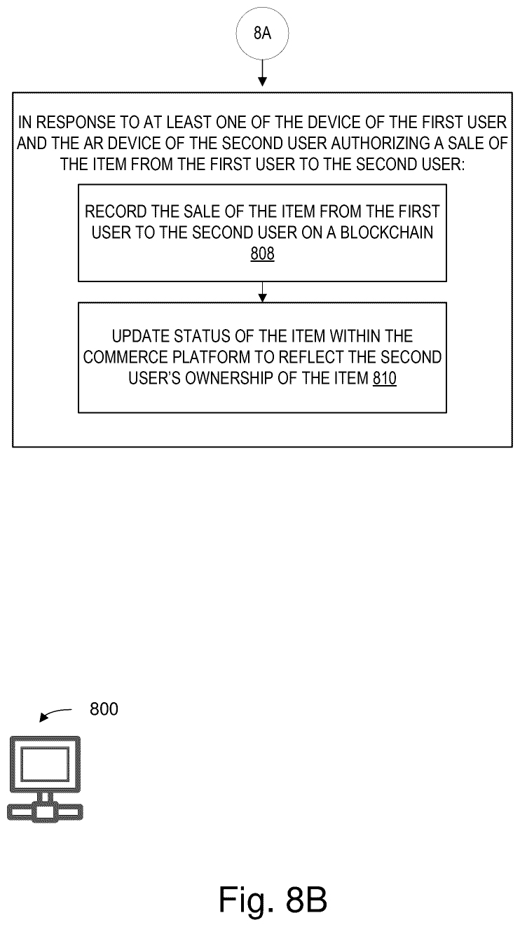

FIGS. 8A-8B illustrate example operations that can be performed by a commerce platform 800 to verify and track asset status, in accordance with various examples of the presently disclosed technology.

Like commerce platform 700 from FIGS. 7A-7D, in certain implementations commerce platform 800 may comprise a combination of: (1) a server-side/back-end system (e.g., implemented as a cloud-based system); (2) signal-emitting tags attached to assets; and (3) application instances implemented/downloaded on user devices (e.g., the device of a first user and the AR device of the second user described below).

Referring now to FIG. 8A, in response to a device of a first user activating a broadcast of information associated with an asset owned by the first user, commerce platform 800 can execute operation 802 to detect an AR device of a second user is within a threshold proximity of the device of the first user and/or within a threshold proximity of the asset.

Commerce platform 800 can use various techniques to make this detection. For example, commerce platform 800 can compare a GPS location of the AR device of the second user to a GPS location of the device of the first user (or the asset) to determine the AR device of the second user is within the threshold proximity of the device of the first user (or the asset). As another example, commerce platform 800 can use wireless communications (e.g., Bluetooth communications, near-field communications, etc.) between the AR device of the second user and the device of the first user (or a signal-emitting tag attached to the asset) to determine the AR device of the second user is within the threshold proximity of the device of the first user (or the asset).

After detecting the AR device of the second user is within the threshold proximity of the device of the first user (or the asset), commerce platform 800 can execute operation 804 to send a notification to the AR device of the second user. The notification may indicate the device of the first user has activated the broadcast of information associated with the asset.

Accordingly, in response to the AR device of the second user requesting to view the information associated with the asset, commerce platform 800 can execute operation 806 to cause the AR device of the second user to display, proximate the first user (and/or the asset), the information associated with the asset. As described above, the information associated with the asset may comprise at least one of: (1) an image of the asset; (2) a price of the asset; (3) an indication the asset is for sale; and (4) an option to purchase the asset from the first user. As described above, such information may presented as (or within) a digital/AR wallet of the first user (see e.g., FIG. 6).

Referring now to FIG. 8B, in response to at least one of the device of the first user and the AR device of the second user authorizing a sale of the asset from the first user to the second user, commerce platform 800 can execute operations 808 and 810 respectively to: (1) record the sale of the asset from the first user to the second user on a blockchain (e.g., a transaction-recording blockchain similar to the transaction-recording blockchain described in conjunction with FIGS. 7A-7D); and (2) update status of the asset within commerce platform 800 to reflect the second user's ownership of the asset.

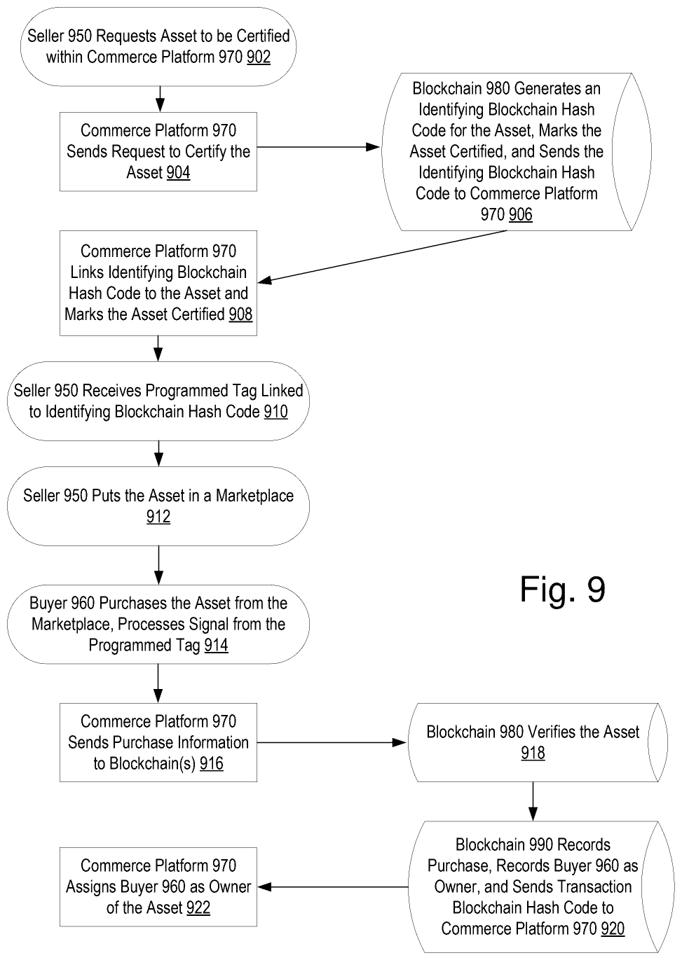

FIG. 9 depicts an example workflow for verifying and tracking asset status, in accordance with various examples of the presently disclosed technology.

As depicted, at operation 902 a seller 950 can request (e.g., via a user device) an asset to be certified within a commerce platform 970.

At operation 904, commerce platform 970 can send the request to certify the asset to a first blockchain 980.

At operation 906, the first blockchain 980 can generate an identifying blockchain hash code for the asset, mark the asset certified, and send the identifying blockchain hash code to commerce platform 970. As described above, the identifying blockchain hash code can uniquely identify the asset within commerce platform 970.

At operation 908, commerce platform 970 can link (or otherwise associate) the identifying blockchain hash code to the asset and mark the asset certified within commerce platform 970.

At operation 910, seller 950 may receive a signal-emitting tag programmed to emit a signal linked to the identifying blockchain hash code for the asset. Seller 950 can attach/affix the signal-emitting tag to the asset.

At operation 912, seller 950 can put the asset in a marketplace. In certain implementations, the marketplace may be a digital marketplace implemented on (or otherwise facilitated by) commerce platform 970.

At operation 914, a buyer 960 purchases the asset from the marketplace. As described above, as part of this purchase, buyer 960 may process a signal from the signal-emitting tag to send information associated with the asset and the purchase to commerce platform 970.

At operation 916, commerce platform 970 can send the purchase information (associated with buyer 960 processing a signal from the signal-emitting tag) to the first blockchain 980.

At operation 918, the first blockchain 980 can verify the asset based on the identifying blockchain hash code.

At operation 920, a second blockchain 990 can record the purchase, record buyer 960 as owner of the asset, and send a transaction blockchain hash code (uniquely identifying the purchase) to commerce platform 970.

Accordingly, at operation 922 commerce platform 970 can assign buyer 960 as owner of the asset.

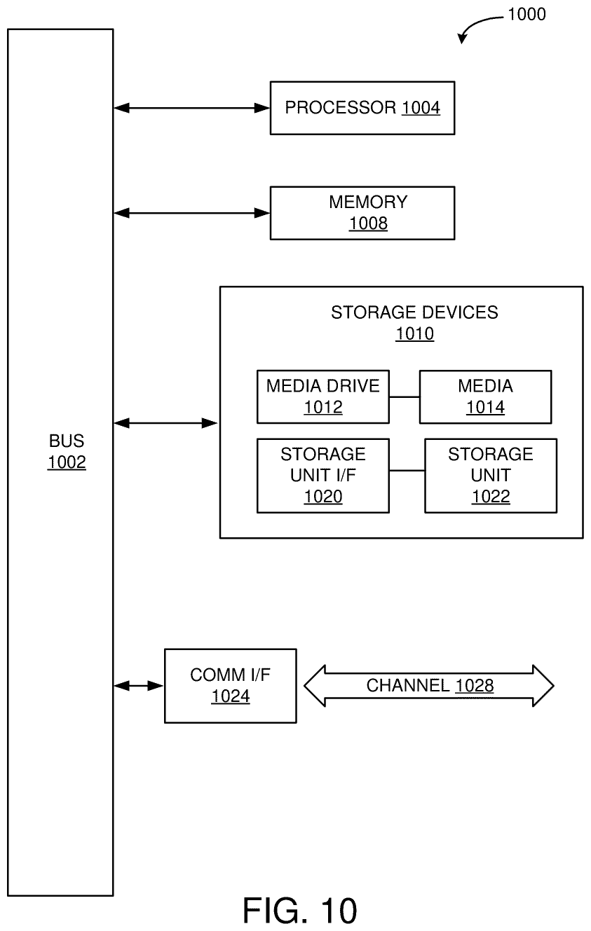

As used herein, the terms circuit and component might describe a given unit of functionality that can be performed in accordance with one or more examples of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 10. Various examples are described in terms of this example-computing component 1000. After reading this description, it will become apparent to a person skilled in the relevant art how to implement the application using other computing components or architectures.

Referring now to FIG. 10, computing component 1000 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 1000 might also represent computing capabilities embedded within or otherwise available to a given device. For example, a computing component might be found in other electronic devices such as, for example, portable computing devices, and other electronic devices that might include some form of processing capability.

Computing component 1000 might include, for example, one or more processors, controllers, control components, or other processing devices. Processor 1004 might be implemented using a general-purpose or special-purpose processing engine such as, for example, a microprocessor, controller, or other control logic. Processor 1004 may be connected to a bus 1002. However, any communication medium can be used to facilitate interaction with other components of computing component 1000 or to communicate externally.

Computing component 1000 might also include one or more memory components, simply referred to herein as main memory 1008. For example, random access memory (RAM) or other dynamic memory, might be used for storing information and instructions to be executed by processor 1004. Main memory 1008 might also be used for storing temporary variables or other intermediate information during execution of instructions to be executed by processor 1004. Computing component 1000 might likewise include a read only memory (“ROM”) or other static storage device coupled to bus 1002 for storing static information and instructions for processor 1004.

The computing component 1000 might also include one or more various forms of information storage mechanism 1010, which might include, for example, a media drive 1012 and a storage unit interface 1020. The media drive 1012 might include a drive or other mechanism to support fixed or removable storage media 1014. For example, a hard disk drive, a solid-state drive, a magnetic tape drive, an optical drive, a compact disc (CD) or digital video disc (DVD) drive (R or RW), or other removable or fixed media drive might be provided. Storage media 1014 might include, for example, a hard disk, an integrated circuit assembly, magnetic tape, cartridge, optical disk, a CD or DVD. Storage media 1014 may be any other fixed or removable medium that is read by, written to or accessed by media drive 1012. As these examples illustrate, the storage media 1014 can include a computer usable storage medium having stored therein computer software or data.

In alternative examples, information storage mechanism 1010 might include other similar instrumentalities for allowing computer programs or other instructions or data to be loaded into computing component 1000. Such instrumentalities might include, for example, a fixed or removable storage unit 1022 and an interface 1020. Examples of such storage units 1022 and interfaces 1020 can include a program cartridge and cartridge interface, a removable memory (for example, a flash memory or other removable memory component) and memory slot. Other examples may include a PCMCIA slot and card, and other fixed or removable storage units 1022 and interfaces 1020 that allow software and data to be transferred from storage unit 1022 to computing component 1000.

Computing component 1000 might also include a communications interface 1024. Communications interface 1024 might be used to allow software and data to be transferred between computing component 1000 and external devices. Examples of communications interface 1024 might include a modem or softmodem, a network interface (such as Ethernet, network interface card, IEEE 802.XX or other interfaces). Other examples include a communications port (such as for example, a USB port, IR port, RS232 port Bluetooth® interface, or other ports), or other communication interfaces. Software/data transferred via communications interface 1024 may be carried on signals, which can be electronic, electromagnetic (which includes optical) or other signals capable of being exchanged by a given communications interface 1024. These signals might be provided to communications interface 1024 via a channel 1028. Channel 1028 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 1008, storage unit 1020, media 1014, and channel 1028. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 1000 to perform features or functions of the present application as discussed herein.

It should be understood that the various features, aspects and functionality described in one or more of the individual examples are not limited in their applicability to the particular example with which they are described. Instead, they can be applied, alone or in various combinations, to one or more other examples, whether or not such examples are described and whether or not such features are presented as being a part of a described example. Thus, the breadth and scope of the present application should not be limited by any of the above-described exemplary examples.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the asset in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the asset described to a given time period or to an asset available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various examples set forth herein are described in terms of exemplary block diagrams, flow charts and other illustrations. As will become apparent to one of ordinary skill in the art after reading this document, the illustrated examples and their various alternatives can be implemented without confinement to the illustrated examples. For example, block diagrams and their accompanying description should not be construed as mandating a particular architecture or configuration.

What is claimed is:

1. A commerce platform comprising:
a signal-emitting tag attached to an asset;
one or more processing resources; and
non-transitory computer-readable medium, coupled to the one or more processing resources, comprising stored instructions that when executed by the one or more processing resources, cause the commerce platform to:
in response to at least one of a device of a first user and a device of a second user processing a signal from the signal-emitting tag:
determine the processed signal is associated with an identifying blockchain hash code that uniquely identifies the asset within the commerce platform,
verify the first user is a valid possessor of the asset based on at least one of the identifying blockchain hash code and a transaction-recording blockchain that records transactions involving the asset on the commerce platform, and
permit the first user and the second user to execute a transaction involving the asset via the commerce platform.

2. The commerce platform of claim 1, wherein the non-transitory computer-readable medium comprises further stored instructions that when executed by the one or more processing resources, cause the commerce platform to:
in response to at least one of the device of the first user and the device of the second user authorizing a transaction to transfer possession of the asset from the first user to the second user:
record the transaction between the first user and the second user on the transaction-recording blockchain, and
update status of the asset within the commerce platform to reflect the second user's valid possession of the asset.

3. The commerce platform of claim 2, wherein the non-transitory computer-readable medium comprises further stored instructions that when executed by the one or more processing resources, cause the commerce platform to:
in response to an augmented reality (AR) device of a third user processing a second signal from the signal-emitting tag, cause the AR device to display, proximate the asset, information associated with the asset.

4. The commerce platform of claim 2, wherein the non-transitory computer-readable medium comprises further stored instructions that when executed by the one or more processing resources, cause the commerce platform to:
in response to an AR device of a third user processing a second signal from the signal-emitting tag:
determine the processed second signal is associated with the identifying blockchain hash code,
verify the second user is a valid possessor of the asset based on at least one of the identifying blockchain hash code and the transaction-recording blockchain, and
cause the AR device to display, proximate the asset, information indicating the second user is the valid possessor of the asset.

5. The commerce platform of claim 2, wherein the non-transitory computer-readable medium comprises further stored instructions that when executed by the one or more processing resources, cause the commerce platform to:
in response to an AR device of a third user initiating a request to view information related to assets certified on the commerce platform within a threshold distance from the AR device:
cause the AR device to display, proximate the asset, information associated with the asset when the asset is within the threshold distance from the AR device.

6. The commerce platform of claim 2, wherein the non-transitory computer-readable medium comprises further stored instructions that when executed by the one or more processing resources, cause the commerce platform to:
receive, from a device of the second user after the transaction between the first user and the second user, an indication that the asset has been stolen;
record, via at least one of the identifying blockchain hash code and the transaction-recording blockchain, that the asset has been stolen; and
change status of the asset within the commerce platform to a stolen status.

7. The commerce platform of claim 6, wherein the non-transitory computer-readable medium comprises further stored instructions that when executed by the one or more processing resources, cause the commerce platform to:
in response to an AR device of a third user processing a second signal from the signal-emitting tag after the status of the asset has been changed to the stolen status, cause the AR device to display, proximate the asset, the stolen status of the asset.

8. The commerce platform of claim 6, wherein the non-transitory computer-readable medium comprises further stored instructions that when executed by the one or more processing resources, cause the commerce platform to:
activate a stain-producing cartridge attached to the asset to explode.

9. The commerce platform of claim 8, further comprising the stain-producing cartridge, wherein the signal-emitting tag and the stain-producing cartridge are packaged together on the asset.

10. The commerce platform of claim 2, wherein the non-transitory computer-readable medium comprises further stored instructions that when executed by the one or more processing resources, cause the commerce platform to:
receive, from a temperature sensor attached to the asset, a signal indicating a temperature;
based on the temperature, determine the asset is invalid;
record, via at least one of the identifying blockchain hash code and the transaction-recording blockchain, that the asset is invalid; and
change status of the asset within the commerce platform to an invalid status.

11. The commerce platform of claim 10, wherein the non-transitory computer-readable medium comprises further stored instructions that when executed by the one or more processing resources, cause the commerce platform to:
in response to an AR device of a third user processing a second signal from the signal-emitting tag after the status of the asset has been changed to the invalid status, cause the AR device to display, proximate the asset, the invalid status of the asset.

12. The commerce platform of claim 10, wherein the non-transitory computer-readable medium comprises further stored instructions that when executed by the one or more processing resources, cause the commerce platform to:
activate an audio-visual indicator of the temperature sensor to indicate the asset is invalid.

13. The commerce platform of claim 12, further comprising the temperature sensor.

14. The commerce platform of claim 1, wherein the identifying blockchain hash code is linked to a separate blockchain from the transaction-recording blockchain.

15. The commerce platform of claim 1, wherein the identifying blockchain hash code is linked to the transaction-recording blockchain.

16. The commerce platform of claim 1, wherein the signal-emitting tag comprises at least one of:
a radio-frequency identification (RFID) tag;
a near-field communication (NFC) tag;
a Millimeter wave (mm-Wave) tag; and
a proximity sensor-based tag.

17. A commerce platform comprising:
one or more processing resources; and
non-transitory computer-readable medium, coupled to the one or more processing resources, comprising stored instructions that when executed by the one or more processing resources, cause the commerce platform to:
in response to at least one of a device of a first user and a device of a second user scanning a code displayed on an asset:
determine the scanned code is associated with an identifying blockchain hash code that uniquely identifies the asset within the commerce platform,
verify the first user is a valid possessor of the asset based on at least one of the identifying blockchain hash code and a transaction-recording blockchain that records transactions involving the asset on the commerce platform, and
permit the first user and the second user to execute a transaction involving the asset via the commerce platform; and
in response to at least one of the device of the first user and the device of the second user authorizing a transaction to transfer possession of the asset from the first user to the second user:
record the transaction between the first user and the second user on the transaction-recording blockchain, and
update status of the asset within the commerce platform to reflect the second user's possession of the asset.

18. A commerce platform comprising:
one or more processing resources; and
non-transitory computer-readable medium, coupled to the one or more processing resources, comprising stored instructions that when executed by the one or more processing resources, cause the commerce platform to:
in response to a device of a first user activating a broadcast of information associated with an asset owned by the first user:
detect an augmented reality (AR) device of a second user is within a threshold proximity of the device of the first user, and
cause the AR device of the second user to display, proximate the first user, the information associated with the asset.

19. The commerce platform of claim 18, wherein detecting the AR device of the second user is within the threshold proximity of the device of the first user comprises at least one of:
comparing a GPS location of the AR device of the second user to a GPS location of the device of the first user to determine the AR device of the second user is within the threshold proximity of the device of the first user; and
using wireless communications between the AR device of the second user and the device of the first user to determine the AR device of the second user is within the threshold proximity of the device of the first user.

20. The commerce platform of claim 18, wherein the information associated with the asset comprises at least one of:
an image of the asset;
a price of the asset;
an indication the asset is for sale; and
an option to purchase the asset from the first user.

21. The commerce platform of claim 20, wherein the non-transitory computer-readable medium comprises further stored instructions that when executed by the one or more processing resources, cause the commerce platform to:
in response to at least one of the device of the first user and the AR device of the second user authorizing a sale of the asset from the first user to the second user:
record the sale of the asset from the first user to the second user on a blockchain, and
update status of the asset within the commerce platform to reflect the second user's ownership of the asset.

22. A commerce platform comprising:
one or more processing resources; and
non-transitory computer-readable medium, coupled to the one or more processing resources, comprising stored instructions that when executed by the one or more processing resources, cause the commerce platform to:
in response to a device of a first user activating a broadcast of information associated with an asset owned by the first user:
detect an augmented reality (AR) device of a second user is within a threshold proximity of the device of the first user, and
send a notification to the AR device of the second user, wherein the notification indicates the device of the first user has activated the broadcast of information associated with the asset; and
in response to the AR device of the second user requesting to view the information associated with the asset, cause the AR device of the second user to display, proximate the first user, the information associated with the asset.
